(19) United States
(12) Patent Application Publication
(10) Pub. No.: US 2024/0323724 A1
(43) Pub. Date: Sep. 26, 2024

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Yali GUO, Dongguan (CN); Zhe FU, Dongguan (CN)

(21) Appl. No.: 18/680,428

(22) Filed: May 31, 2024

Related U.S. Application Data
(63) Continuation of application No. PCT/CN2022/070801, filed on Jan. 7, 2022.

(51) Int. Cl. H04W 24/08; H04M 15/00; H04W 28/02

(52) U.S. Cl. CPC H04W 24/08; H04M 15/66; H04W 28/0268

(57) ABSTRACT

This application provides a communication method and a communications apparatus. The communication method includes: sending, by a PCF, a PCC rule to an SMF. The PCC rule includes first RTT control information corresponding to a service data flow of a target service, and the PCC rule is used by the SMF to control, according to the first RTT control information, a QoS flow for transmitting the service data flow.

### CROSS-REFERENCE TO RELATED APPLICATIONS

This application is a continuation of International Application No. PCT/CN2022/070801, filed on Jan. 7, 2022, the disclosure of which is hereby incorporated by reference in its entirety.

### TECHNICAL FIELD

This application relates to the field of communications technologies, and more specifically, to a communication method and a communications apparatus.

### BACKGROUND

Some services (such as cloud gaming and interactive services of an artificial intelligence type) have a relatively high requirement on a round-trip time (a total delay of round-trip transmission) corresponding to a service data flow. In a related technology, a round-trip time may be controlled by an application layer. For example, when an application server may learn that a received upstream data transmission delay is relatively large by using a time label of the application layer, the application server may send a lower downstream data transmission delay requirement to a network side.

However, the control of the application layer takes a long time to reach the network side for transmission control, and therefore the round-trip time cannot be controlled in time, and user experience of some services may not be met.

### SUMMARY

This application provides a communication method and a communications apparatus, to improve timeliness of control on a round-trip time corresponding to a service data flow.

According to a first aspect, a communication method is provided, including: sending, by a policy control function PCF, a policy control and charging PCC rule to a session management function SMF, where the PCC rule includes first round-trip time RTT control information corresponding to a service data flow of a target service, and the PCC rule is used by the SMF to control, according to the first RTT control information, a quality of service QoS flow for transmitting the service data flow.

According to a second aspect, a communication method is provided, including: determining, by a policy control function PCF, first round-trip time RTT control information corresponding to a service data flow of a target service; sending, by the PCF, a policy control and charging PCC rule to a session management function SMF, where the service data flow includes an upstream service data flow and a downstream service data flow, the PCC rule includes a first PCC rule and a second PCC rule, the first PCC rule includes an uplink transmission delay requirement corresponding to the upstream service data flow, the second PCC rule includes a downlink transmission delay requirement corresponding to the downstream service data flow, a delay monitoring indication is further included in the first PCC rule and/or the second PCC rule, and the delay monitoring indication is used to monitor an actual transmission delay of the upstream service data flow and/or the downstream service data flow; and adjusting, by the PCF, the uplink transmission delay requirement or the downlink transmission delay requirement according to a received monitoring result and the first RTT control information.

According to a third aspect, a communication method is provided, including: receiving, by a session management function SMF, a policy control and charging PCC rule sent by a policy control function PCF, where the PCC rule includes first round-trip time RTT control information corresponding to a service data flow of a target service; and controlling, by the SMF according to the first RTT control information, a quality of service QoS flow for transmitting the service data flow.

According to a fourth aspect, a communication method is provided, including: receiving, by an access network device, control information of a quality of service QoS flow sent by a session management function SMF, where the control information of the QoS flow includes second round-trip time RTT control information corresponding to the QoS flow; and scheduling, by the access network device, a radio resource according to the control information of the QoS flow, to perform RTT control on the QoS flow.

According to a fifth aspect, a communication method is provided, including: sending, by an application function AF, a request to a policy control function PCF, where the request includes a round-trip time RTT demand corresponding to a service data flow of a target service, the request is used by the PCF to determine a policy control and charging PCC rule corresponding to the service data flow according to the RTT demand, and the PCC rule includes first RTT control information corresponding to the service data flow.

According to a sixth aspect, a communications apparatus is provided, where the communications apparatus is a policy control function PCF entity, and the PCF entity includes: a sending module, configured to send a policy control and charging PCC rule to a session management function SMF, where the PCC rule includes first round-trip time RTT control information corresponding to a service data flow of a target service, and the PCC rule is used by the SMF to control, according to the first RTT control information, a quality of service QoS flow for transmitting the service data flow.

According to a seventh aspect, a communications apparatus is provided, where the communications apparatus is a policy control function PCF entity, and the PCF entity includes: a determining module, configured to determine first round-trip time RTT control information corresponding to a service data flow of a target service; a sending module, configured to send a policy control and charging PCC rule to a session management function SMF, where the service data flow includes an upstream service data flow and a downstream service data flow, the PCC rule includes a first PCC rule and a second PCC rule, the first PCC rule includes an uplink transmission delay requirement corresponding to the upstream service data flow, the second PCC rule includes a downlink transmission delay requirement corresponding to the downstream service data flow, a delay monitoring indication is further included in the first PCC rule and/or the second PCC rule, and the delay monitoring indication is used to monitor an actual transmission delay of the upstream service data flow and/or the downstream service data flow; and an adjustment module, configured to adjust the uplink transmission delay requirement or the downlink transmission delay requirement according to a received monitoring result and the first RTT control information.

According to an eighth aspect, a communications apparatus is provided, where the communications apparatus is a session management function SMF entity, and the SMF entity includes: a receiving module, configured to receive a policy control and charging PCC rule sent by a policy control function PCF, where the PCC rule includes first round-trip time RTT control information corresponding to a service data flow of a target service; and a control module, configured to control, according to the first RTT control information, a quality of service QoS flow for transmitting the service data flow.

According to a ninth aspect, a communications apparatus is provided, where the communications apparatus is an access network device, and the access network device includes: a receiving module, configured to receive control information of a quality of service QoS flow sent by a session management function SMF, where the control information of the QoS flow includes second round-trip time RTT control information corresponding to the QoS flow; and a scheduling module, configured to schedule a radio resource according to the control information of the QoS flow, to perform RTT control on the QoS flow.

According to a tenth aspect, a communications apparatus is provided, where the communications apparatus is an application function AF, and the AF entity includes: a sending module, configured to send a request to a policy control function PCF, where the request includes a round-trip time RTT demand corresponding to a service data flow of a target service, the request is used by the PCF to determine a policy control and charging PCC rule corresponding to the service data flow according to the RTT demand, and the PCC rule includes first RTT control information corresponding to the service data flow.

According to an eleventh aspect, a communications apparatus is provided, including a processor, a memory, and a communications interface, where the memory is configured to store one or more computer programs, and the processor is configured to invoke the computer program in the memory, so that a communications apparatus executes some or all of steps in a method according to any one of the first aspect to the fifth aspect.

According to a twelfth aspect, an embodiment of this application provides a communications system, where the system includes the foregoing communications apparatus (the PCF entity, the SMF entity, the access network device, the AF entity, or the like). In another possible design, the system may further include another device that interacts with the communications apparatus in the solutions provided in embodiments of this application.

According to a thirteenth aspect, an embodiment of this application provides a computer-readable storage medium, where the computer-readable storage medium stores a computer program, and the computer program causes a communications apparatus to execute some or all of steps in a method according to any one of the first aspect to the fifth aspect.

According to a fourteenth aspect, an embodiment of this application provides a computer program product, where the computer program product includes a non-transitory computer-readable storage medium that stores a computer program, and the computer program is operable to cause a communications apparatus to perform some or all of steps of a method according to any one of the first aspect to the fifth aspect. In some implementations, the computer program product may be a software installation package.

According to a fifteenth aspect, an embodiment of this application provides a chip, where the chip includes a memory and a processor, and the processor may invoke a computer program from the memory and run the computer program, to implement some or all of steps described in a method according to any one of the first aspect to the fifth aspect.

In embodiments of this application, a policy control and charging rule sent by a policy control function to a session management function directly includes first round-trip time control information corresponding to a service data flow of a target service, so that a network side may directly control a round-trip time corresponding to the service data flow according to the first round-trip time control information. Therefore, timeliness of the control may be improved.

### BRIEF DESCRIPTION OF DRAWINGS

FIG. 1 is a system architectural diagram of a wireless communications system to which embodiments of this application are applicable.

FIG. 2 is a schematic diagram of a QoS model according to an embodiment of this application.

FIG. 3 is a schematic flowchart of a communication method according to an embodiment of this application.

FIG. 4 is a schematic flowchart of a communication method according to another embodiment of this application.

FIG. 5 is a schematic flowchart of a communication method according to still another embodiment of this application.

FIG. 6 is a schematic flowchart of a communication method according to yet another embodiment of this application.

FIG. 7 is a schematic flowchart of a communication method according to still yet another embodiment of this application.

FIG. 8 is a schematic flowchart of a communication method according to a further embodiment of this application.

FIG. 9 is a schematic flowchart of a communication method according to a still further embodiment of this application.

FIG. 10 is a schematic structural block diagram of a communications apparatus according to an embodiment of this application.

FIG. 11 is a schematic structural block diagram of a communications apparatus according to another embodiment of this application.

FIG. 12 is a schematic structural block diagram of a communications apparatus according to still another embodiment of this application.

FIG. 13 is a schematic structural block diagram of a communications apparatus according to yet another embodiment of this application.

FIG. 14 is a schematic structural block diagram of a communications apparatus according to still yet another embodiment of this application.

FIG. 15 is a schematic structural diagram of an apparatus according to an embodiment of this application.

### DESCRIPTION OF EMBODIMENTS

### Communications System Architecture

Technical solutions of embodiments of this application may be applied to various communications systems, such as a 5th generation (5G) system or a new radio (NR) system, a long-term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

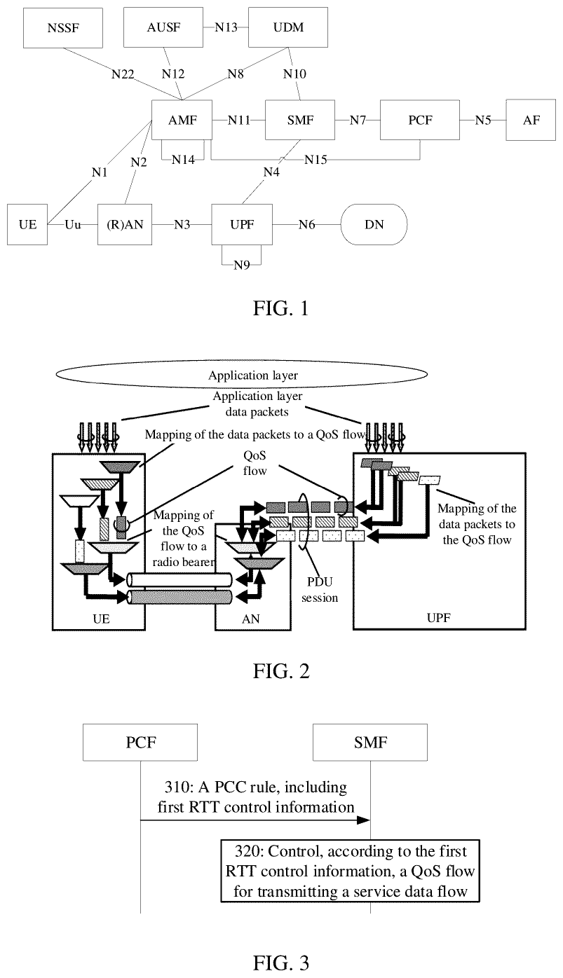

FIG. 1 shows a wireless communications system 100 to which embodiments of this application are applicable. For example, the communications system is a 5G system architecture. The wireless communications system 100 may include a terminal device 110, an access network (AN) device 120, a user plane function (UPF) entity 130, an access and mobility management function (AMF) entity 140, a session management function (SMF) entity 150, a policy control function (PCF) entity 160, an application function (AF) entity 170, and a data network (DN) 180.

The following provides examples to describe functions of parts or functional entities involved in the wireless communications system 100 in a 5G network.

Terminal device 110: The terminal device may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like.

Access network device 120: The access network device may be configured to provide a network access function for an authorized terminal device in a specific area, and may use transmission channels of different quality according to a level, a service demand, and the like of the terminal device. The access network device may manage a radio resource, and provide an access service for the terminal device, to complete forwarding of a control signal and data between the terminal device and a core network.

The access network device may be a device in a wireless network. The access network device may also be referred to as a radio access network (RAN) device or a network device. For example, the access network device may be a base station. The access network device in embodiments of this application may be a radio access network (RAN) node (or device) that connects the terminal device to a wireless network. The base station may broadly cover various names in the following, or may be replaced with the following names: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may refer to a communications module, a modem, or a chip disposed in the device or apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communications system, or the like. The base station may support networks of a same access technology or different access technologies. A specific technology and a specific device form used by the access network device are not limited in embodiments of this application.

The base station may be fixed or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device that communicates with another base station.

In some deployments, the access network device in embodiments of this application may be a CU or a DU, or the access network device includes a CU and a DU. A gNB may further include an AAU.

The access network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the access network device and the terminal device are located is not limited.

UPF entity 130: The UPF is a user plane function in the core network, and may be responsible for forwarding and receiving of user data (for example, a service data flow) in the terminal device. For example, the UPF may receive user data from the DN, and transmit the user data to the terminal device by using the access network device. Alternatively, the UPF may receive user data from the terminal device by using the access network device, and then forward the user data to the DN. A transmission resource and a scheduling function in the UPF that provide a service for the terminal device are managed and controlled by the SMF. In some embodiments, the UPF may be divided into an intermediate UPF (I-UPF) and an anchor UPF (A-UPF). The I-UPF is connected to an access network, the A-UPF is a UPF of a session anchor, and the A-UPF may also be referred to as a PDU session anchor (PSA).

AMF entity 140: The AMF is a mobility management function in the core network, and may be configured to implement functions other than session management in functions of a mobility management entity (MME), such as certified monitoring or access authorization (or authentication). In some embodiments, in addition to performing mobility management on the terminal device, the AMF may further be responsible for forwarding of a message related to session management between the terminal device and the SMF.

SMF entity 150: The SMF is a session management function in the core network, and is mainly responsible for session management, internet protocol (IP) address allocation and management of the terminal device, selection of a manageable user plane function, policy control, a termination of a charging function interface, downstream data notification, and configuration of routing information for a user plane function.

PCF entity 160: The PCF is a policy management function in the core network, and may be responsible for formulation of policies related to mobility management, session management, charging, and the like of the terminal device. Specifically, the PCF may provide policy rule information and the like for a functional entity (for example, the AMF entity or the SMF entity) on a control plane, to manage and control mobility management, session management, and the like of the terminal device.

AF entity 170: The AF mainly supports interaction with a 3rd generation partnership project (3GPP) core network, to provide services, for example, affecting a data routing decision, a policy control function, or providing a network side with some services of a third party. In other words, the AF may be mainly configured to transfer a demand of an application side on the network side. In some embodiments, the AF may be understood as a third-party server, for example, an application server on an internet, which provides related service information, including providing the PCF with quality of service demand information corresponding to a service, and sending user plane data information of a service to an A-UPF. In some embodiments, the AF may also be a content provider (CP).

DN 180: The DN refers to a network that may be used to provide transmission data. The DN may be a private network, for example, a local area network, or may be an external network that is not managed or controlled by an operator, for example, an internet, or may be a dedicated network jointly deployed with operators, for example, a network that provides an IP multimedia core network subsystem (IMS) service.

It should be understood that the foregoing functional entities in the core network may also be referred to as network elements, which is not limited in this application. For example, the UPF entity may also be referred to as a UPF network element, and the AMF entity may also be referred to as an AMF network element. It should also be understood that, in some embodiments, the xx functional entity or the xx network element may also be directly referred to as the xx, for example, the UPF entity (or the UPF network element) may be referred to as the UPF, and the AMF entity (or the AMF network element) may be referred to as the AMF. For ease of description, the xx (such as the UPF or the AMF) mentioned in embodiments of this application may refer to the xx entity or the xx network element. Details are not described again in the following.

Optionally, the wireless communications system 100 may further include another network entity such as a network slice selection function (NSSF) entity, an authentication server function (AUSF) entity, or a unified data management (UDM) entity. This is not limited in embodiments of this application.

In the wireless communications system 100 shown in FIG. 1, the parts or functional entities may communicate with each other by using interfaces. For example, the terminal device may perform an access stratum connection to the AN and exchange transmission of an access stratum message and wireless data by using a Uu interface. The terminal device may perform a non access stratum (NAS) connection to the AMF and exchange a NAS message by using an N1 interface. The AN may be connected to the AMF by using an N2 interface, to transfer radio bearer control information from the core network side to the AN. The UPF may perform data transmission with the AN by using an N3 interface, and perform data transmission with the DN by using an N6 interface, and the like. For interfaces used to connect other parts or functional entities, refer to FIG. 1. Details are not described herein again.

It should be understood that the access network device, the AMF, the SMF, the UPF, the PCF, and the like shown in FIG. 1 are only names, and the names do not constitute any limitation on the devices. In a 5G network and another network in the future, entities corresponding to the access network device, the AMF, the SMF, the UPF, the PCF, and the like may also be other names. This is not specifically limited in embodiments of this application.

It should be understood that all or some of functions of the communications device in this application may also be implemented by software functions running on hardware, or by virtualization functions instantiated on a platform (for example, a cloud platform).

It should be understood that the system architecture described in embodiments of this application is intended to describe the technical solutions in embodiments of this application more clearly, and does not constitute any limitation on the technical solutions provided in embodiments of this application. It may be learned by a person skilled in the art that, with evolution of a network architecture, embodiments of this application may also be applicable to similar technical problems.

Quality of Service Flow (QoS flow)

To implement higher-rate experience and higher-bandwidth access capabilities, and ultra-reliable information exchange with a lower delay, some communications systems (for example, an NR system) introduce a concept of quality of service flow (QoS flow), which may also be referred to as a QoS flow in some embodiments. A QoS flow is the finest QoS differentiation granularity in a protocol data unit (PDU) session, that is, a difference between two PDU sessions lies in that QoS flows of the two PDU sessions are different.

A QoS flow identifier (QFI) may be used to identify a QoS flow, for example, one QFI may be used to identify one QoS flow. User plane data with a same QFI in a PDU session obtains same forwarding processing (such as same scheduling and a same admission threshold).

In a same PDU session, a plurality of QoS flows may exist, to support different QoS requirements of different types of data transmission. For example, video, voice, and web browsing services may need to use different QoS flows. In other words, a PDU session may have a plurality of (a maximum of 64) QoS flows, but each QoS flow has a different QFI (value range: 0 to 63). In some embodiments, QFIs of two PDU sessions of a terminal device may be repeated.

In some embodiments, a QoS model may be established based on a QoS flow, for example, a QoS model of a 5G network. The QoS model of the 5G network may support a QoS flow with a guaranteed bit rate (GBR) and a QoS flow with a non-guaranteed bit rate (Non-GBR). In some embodiments, the QoS model of the 5G network may also support reflective QoS.

In some embodiments, after accessing a network (for example, a 5G network) by using a Uu interface, a terminal device may establish a QoS flow to perform data transmission under control of an SMF. For example, when a PDU session is established, the SMF may configure a corresponding QoS parameter for a UPF, an AN, and the terminal device.

FIG. 2 shows a QoS model according to an embodiment of this application. FIG. 2 illustrates a rule procedure for classification and marking of user plane data and mapping of a QoS flow to an AN resource. For upstream data transmission, a terminal device may perform matching on a data packet according to a QoS rule, and transmit the data packet upstream from a matched QoS flow and a corresponding AN channel. For downstream data transmission, a UPF may perform matching on a data packet according to a packet detection rule (PDR), and transmit the data packet downstream from a matched QoS flow and a corresponding AN channel. If a data packet does not match any QoS rule (upstream) or PDR (downstream), the data packet may be dropped by the terminal device or the UPF.

After a corresponding QoS flow is established under control of an SMF, the SMF may provide an access network device with control information of each QoS flow. For example, control information of a QoS flow (which may also be referred to as configuration information of the QoS flow) may specifically include information such as a bit rate requirement, a delay requirement, and a bit error rate requirement. For each QoS flow, the access network device schedules a radio resource according to control information of the QoS flow that is received from the SMF, to ensure a QoS requirement of the QoS flow. In some embodiments, both an upstream service data flow (a data flow sent by the terminal device to a peer device by using a cellular network (for example, a 5G network)) and a downstream service data flow (a data flow sent by the peer device to the terminal device by using the cellular network) may be transmitted in a QoS flow. Herein, the peer device may refer to a peer application server or a peer terminal device.

It should be noted that an upstream service data flow and a downstream service data flow in a QoS flow have a same delay requirement. If an upstream service data flow and a downstream service data flow of a service have different delay requirements, transmission may be performed by using different QoS flows. A delay herein may refer to a delay of data transmission between the terminal device and the UPF.

Specifically, in an example, a process of determining control information of a QoS flow may be described as follows: A PCF sends a policy control and charging (PCC) rule at a service data flow (SDF) level to the SMF, where the PCC rule includes a QoS requirement, and the SMF may bind different PCC rules according to the QoS requirement. The SMF may bind PCC rules that have a same QoS requirement to a same QoS flow, and allocate a QFI to the bound QoS flow. Then, the SMF sends the bound QoS flow and the QFI to an AN. When receiving a downstream service data flow sent by the UPF, the AN may send, according to the QoS flow and the QFI that are received, the downstream service data flow to the terminal device by using a radio bearer of corresponding quality of service through resource scheduling. Alternatively, when receiving an upstream service data flow sent by the terminal device, the AN may send, according to the QoS flow and the QFI that are received, the upstream service data flow to the UPF by using a radio bearer of corresponding quality of service through resource scheduling. This ensures that service data obtains corresponding quality of service, to meet a delay requirement of the service data.

With rapid development of mobile communications technologies, many new services are derived, such as AR, VR, cloud gaming, and interactive services of an artificial intelligence type. These new services are more concerned about a total round-trip delay in a round of interaction between a terminal device and a peer device. In other words, these new services have a relatively high requirement on a round-trip time (RTT) corresponding to a service data flow, instead of a separate delay of an upstream service data flow or a separate delay of a downstream service data flow. In a related technology, RTT control may be performed by an application layer, for example, RTT control may be performed by using an application layer server. Specifically, when it is learned by using a time label of the application layer that a received upstream data transmission delay is relatively large, a lower transmission delay requirement is sent to a network side for downstream data. Therefore, the downstream data may reach the terminal device more quickly, and further, a total delay in a round of upstream and downstream interaction does not exceed an RTT requirement. However, the control of the application layer takes a long time to reach the network side for transmission control, and therefore the RTT cannot be controlled in time, and user experience of such new services (services with a relatively high RTT requirement) may not be met.

To resolve the foregoing problem, embodiments of this application provide a communication method and a communications apparatus, to improve timeliness of RTT control corresponding to a service data flow. The following describes embodiments of this application in detail with reference to the accompanying drawings.

Embodiments of this application aim to improve timeliness of control by directly controlling an RTT corresponding to a service data flow on a network side. Based on this, embodiments of this application provide two embodiments. Embodiment 1 aims to control an RTT corresponding to a service data flow by using an access network device, while Embodiment 2 aims to control an RTT corresponding to a service data flow by using a PCF. The following separately describes the two embodiments in detail.

It should be noted that embodiments of this application are described from a perspective of interaction between all parts or functional entities. However, this does not mean that the implementation solutions of this application require cooperation between all parts or functional entities or are limited to some parts or functional entities that are listed to resolve the technical problem. When the parts or functional entities are used together, a better technical effect may be obtained.

### Embodiment 1

FIG. 3 is a schematic flowchart of a communication method according to an embodiment of this application. The method shown in FIG. 3 is described from a perspective of interaction between a PCF and an SMF. The PCF and the SMF may be, for example, the PCF and the SMF shown in FIG. 1. The method shown in FIG. 3 includes step S310 and step S320.

In step S310, the PCF sends a PCC rule to the SMF. The PCC rule includes first RTT control information corresponding to a service data flow of a target service.

In this embodiment of this application, the target service may be a service that has a requirement on an RTT of a service data flow. In other words, the target service may be a service that is concerned about a total round-trip delay in a round of interaction between a terminal device and a peer device. In some embodiments, the target service may be, for example, an AR service, a VR service, a cloud gaming service, an interactive service of an artificial intelligence type, or the like. In these service modes, some service data flows need to be transmitted (including both transmission of an upstream service data flow and transmission of a downstream service data flow) between a user-side terminal device and a peer terminal device, which has a relatively high requirement on an RTT. It should be noted that the target service in embodiments of this application is not limited to the several service types listed above, as long as the target service is a service that has a requirement on an RTT of a service data flow.

A data type carried in the service data flow of the target service is not limited in embodiments of this application. In some embodiments, the data carried in the service data flow may be multimedia data, for example, may include a video picture, voice data, and the like. In some embodiments, the data carried in the service data flow may be data collected by a terminal device, for example, may include sensor data on the terminal device, action data detected by the terminal device, and the like.

A process of generating the PCC rule is not limited in embodiments of this application. For example, the PCF may generate the PCC rule by itself according to local configuration of the PCF, an operator setting, and the like. Alternatively, the PCF may generate the PCC rule according to information obtained from an AF.

In embodiments of this application, when a service data flow of the target service needs to be transmitted, the PCF may send the PCC rule corresponding to the service data flow to be transmitted to the SMF, and the PCC rule includes the first RTT control information corresponding to the service data flow. Therefore, the SMF may bind the received PCC rule to a QoS flow that may provide corresponding QoS guarantee.

In some embodiments, the first RTT control information includes an RTT requirement corresponding to the service data flow, and the RTT requirement is used to limit that an actual RTT of the service data flow cannot exceed the RTT requirement. In some embodiments, the RTT requirement may also be understood as a target RTT corresponding to the service data flow.

In an example, the RTT requirement may be data of a numeric type, for example, the RTT requirement may be a fixed value. For example, if an RTT requirement corresponding to a service data flow is 200 ms, an actual RTT of the service data flow cannot exceed 200 ms. Alternatively, the RTT requirement may also be a changing value, for example, different RTT requirements may be configured for different service types.

In another example, the RTT requirement may be indicated by using a QoS identifier. The QoS identifier may be a scalar that is pointed to a plurality of QoS characteristic values, such as a transmission delay requirement and a bit error rate. In a case in which a QoS identifier mapping table is preconfigured or standardized in a network, a QoS identifier may represent a corresponding QoS characteristic value. For example, in a 5G system, a 5G QoS identifier (5QI) may be used for indication. For example, a 5QI mapping table shown in Table 1 has been standardized in the 5G system. Therefore, 5QI=66 may be understood as that a packet delay budget (PDB) is 100 ms, or may be understood as that a delay requirement is 100 ms. The PDB represents a single direction delay between the terminal device and the UPF.

TABLE 1

| 5QI | Priority | PDB | Bit error rate |
|---|---|---|---|
| 66 | 20 | 100 ms | 10⁻² |

In some embodiments, the first RTT control information is further used to instruct to control the RTT of the service data flow, for example, may be used to instruct a network side (for example, an access network device) to control the RTT of the service data flow.

Optionally, in addition to the first RTT control information corresponding to the service data flow, the PCC rule may further include information such as a bit rate requirement and a bit error rate requirement.

In step S320, the SMF controls, according to the first RTT control information, a QoS flow for transmitting the service data flow.

For example, after receiving the PCC rule sent by the PCF, the SMF may determine the QoS flow corresponding to the service data flow according to the first RTT control information in the PCC rule, and bind the service data flow corresponding to the PCC rule to the QoS flow.

In embodiments of this application, the PCC rule sent by the PCF to the SMF directly includes the first RTT control information corresponding to the service data flow of the target service, so that the network side may directly control, according to the first RTT control information, the RTT corresponding to the service data flow. Therefore, timeliness of the control may be improved.

In some embodiments, that the SMF controls, according to the first RTT control information, a QoS flow for transmitting the service data flow may refer to that: the SMF determines the QoS flow for transmitting the service data flow according to the first RTT control information. In some embodiments, that the SMF controls, according to the first RTT control information, a QoS flow for transmitting the service data flow may refer to that: the SMF sends control information of the QoS flow to an access network device. In some embodiments, that the SMF controls, according to the first RTT control information, a QoS flow for transmitting the service data flow may refer to that: the SMF determines the QoS flow for transmitting the service data flow according to the first RTT control information, and sends control information of the QoS flow to an access network device.

In an implementation, when the first RTT control information includes the RTT requirement, the SMF may directly determine the QoS flow for transmitting the service data flow according to the RTT requirement. In another implementation, when the first RTT control information is used to instruct to control the RTT of the service data flow, the SMF may determine the QoS flow for transmitting the service data flow according to the first RTT control information and a single direction delay requirement in the PCC rule, or according to the first RTT control information, and an uplink transmission delay requirement and a downlink transmission delay requirement in the PCC rule. For specific content of the single direction delay requirement, the uplink transmission delay requirement, and the downlink transmission delay requirement, refer to the following. Details are not described herein again.

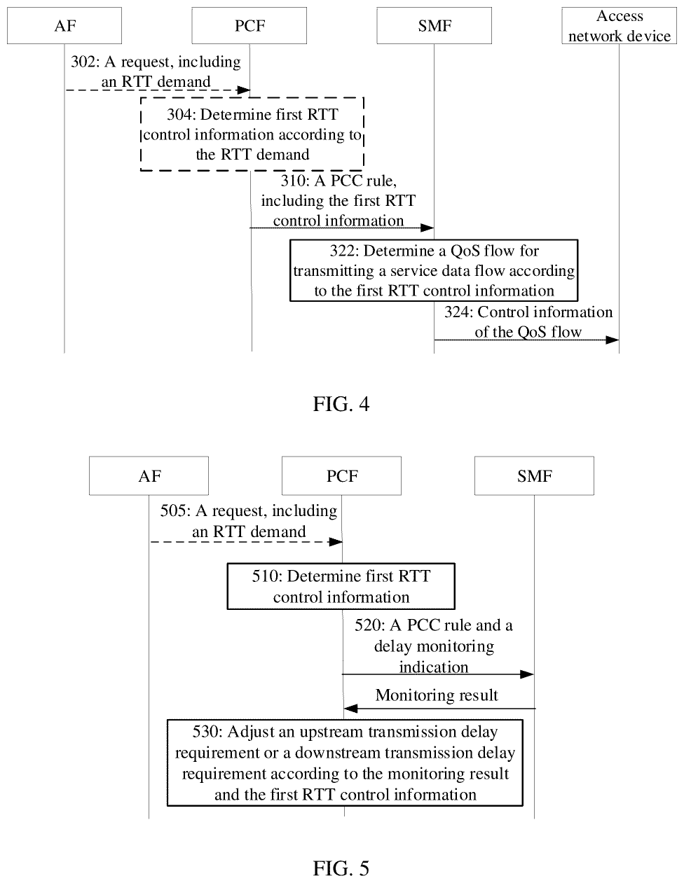

FIG. 4 is a schematic flowchart of a communication method according to another embodiment of this application. Referring to FIG. 4, in some embodiments, step S320 may include step S322 and step S324.

In step S322, the SMF determines the QoS flow for transmitting the service data flow according to the first RTT control information.

In some embodiments, the QoS flow determined by the SMF may only be used to transmit the service data flow that includes the target service. That is, the QoS flow determined by the SMF only transmits the service data flow corresponding to the target service, to accurately control the RTT of the service data flow transmitted in the QoS flow.

In some other embodiments, the QoS flow determined by the SMF may be used to transmit the service data flow that includes the target service and a service data flow that has the same first RTT control information as the service data flow that includes the target service. In other words, the QoS flow determined by the SMF may transmit a plurality of service data flows that have a same requirement on the RTT, to save QoS flow resources.

In an implementation, all service data flows bound to a same QoS flow accept a same data transmission processing and a same radio resource scheduling manner.

In some embodiments, after determining the QoS flow, the SMF may allocate a QFI to the QoS flow. Different QFIs may be allocated to different QoS flows.

In step S324, the SMF sends control information of the QoS flow to the access network device. The control information of the QoS flow includes second RTT control information corresponding to the QoS flow, so that the access network device may perform radio resource scheduling according to the control information of the QoS flow, to implement RTT control on the QoS flow.

It should be noted that the second RTT control information is determined by the SMF according to the first RTT control information. In an implementation, the second RTT control information is generated according to the first RTT control information. For example, after receiving the first RTT control information in the PCC rule, the SMF may configure the first RTT control information in the control information of the QoS flow, to generate the corresponding second RTT control information, where a value of an RTT required in the second RTT control information may be the same as the value of the RTT required in the first RTT control information.

In some embodiments, when the first RTT control information includes the RTT requirement, the second RTT control information may correspondingly include the same RTT requirement. In some embodiments, when the first RTT control information is used to instruct to control the RTT of the service data flow, correspondingly, the second RTT control information may be used to instruct to control an RTT of the QoS flow.

As mentioned above, the first RTT control information may be used to instruct to control the RTT of the service data flow. Specifically, in some embodiments, when the first RTT control information is used to instruct to control the RTT of the service data flow, the PCC rule sent by the PCF to the SMF may further include a first transmission delay requirement. The first transmission delay requirement may be used to indicate a single direction delay requirement corresponding to the service data flow.

It should be noted that, that the first transmission delay requirement is used to indicate a single direction delay requirement corresponding to the service data flow may refer to that: the first transmission delay requirement is used to indicate an uplink transmission delay requirement corresponding to the service data flow; or the first transmission delay requirement is used to indicate a downlink transmission delay requirement corresponding to the service data flow; or the first transmission delay requirement is used to indicate the uplink transmission delay requirement and the downlink transmission delay requirement that correspond to the service data flow, in this case, the first transmission delay requirement indicates that the uplink transmission delay requirement and the downlink transmission delay requirement that correspond to the service data flow are equal to each other, and are both equal to the first transmission delay requirement. For example, when the first transmission delay requirement is 100 ms, it may indicate that the uplink transmission delay requirement and the downlink transmission delay requirement of the service data flow are both 100 ms. In some embodiments, a QoS identifier may be used to indicate the first transmission delay requirement and/or the single direction delay requirement, for example, a 5QI may be used to indicate. For specific content of the QoS identifier, refer to the foregoing description. Details are not described herein again.

Based on this, in some embodiments, the first RTT control information and the first transmission delay requirement may be used to jointly indicate the RTT requirement corresponding to the service data flow. The first RTT control information indicates that the RTT control needs to be performed on the service data flow. The specific RTT requirement may be obtained according to the first transmission delay requirement. As described above, the first transmission delay requirement may be used to indicate that the uplink transmission delay requirement and the downlink transmission delay requirement that correspond to the service data flow are equal to each other, and are both equal to the first transmission delay requirement. In this case, the first RTT control information and the first transmission delay requirement may be used to indicate that the RTT requirement corresponding to the service data flow is equal to twice the first transmission delay requirement. In an example, when the first transmission delay requirement is 100 ms, and the first RTT control information and the first transmission delay requirement are used to jointly indicate the RTT requirement corresponding to the service data flow, it may be learned that the RTT requirement is equal to twice the first transmission delay requirement, that is, the RTT requirement is 200 ms. The RTT requirement is used to indicate that the actual RTT corresponding to the service data flow cannot exceed the RTT requirement.

It should be noted that when the first RTT control information and the first transmission delay requirement are used to jointly indicate the RTT requirement corresponding to the service data flow, priority may be given to meeting the corresponding RTT requirement, and then the corresponding single direction delay requirement is considered. Alternatively, only meeting the corresponding RTT requirement may be considered, and the single direction delay requirement does not need to be considered. In an example, when the first transmission delay requirement is 100 ms and an actual uplink transmission delay is 30 ms, a downlink transmission delay may be appropriately slowed down, for example, may be slowed down to 90 ms, 100 ms, or the like. A preset single direction limitation of 100 ms may even be exceeded, and the downlink transmission delay is slowed down to 150 ms, 170 ms, or the like.

Correspondingly, in some embodiments, when the PCC rule includes the first transmission delay requirement, the control information of the QoS flow may further include a second transmission delay requirement, and the second transmission delay requirement may be used to indicate a single direction delay requirement corresponding to the QoS flow. For specific content of the single direction delay requirement, refer to the foregoing description. Details are not described herein again.

In some embodiments, the second RTT control information and the second transmission delay requirement may be used to jointly indicate the RTT requirement corresponding to the QoS flow. The second RTT control information indicates that the RTT control needs to be performed on the QoS flow. The specific RTT requirement may be obtained according to the second transmission delay requirement. For example, the second transmission delay requirement may be used to indicate that an uplink transmission delay requirement and a downlink transmission delay requirement that correspond to the QoS flow are equal to each other, and are both equal to the second transmission delay requirement. In this case, the second RTT control information and the second transmission delay requirement may be used to indicate that an RTT requirement corresponding to the QoS flow is equal to twice the second transmission delay requirement.

In some embodiments, the PCC rule may further include description information of the service data flow, which is used to define the service data flow. In some embodiments, the description information of the service data flow may be filter information of the service data flow. Specific content of the filter information of the service data flow is not limited in embodiments of this application. For example, filter information of data may be a feature of a packet header of user plane data. In an example, when the user plane data is data of an IP type, the filter information of the data may include a source IP address, a target IP address, a source port number, a target port number, and the like. In another example, when the user plane data is data of an ethernet type, the filter information of the data may include a source MAC address, a target MAC address, and the like.

In some embodiments, the service data flow may include an upstream service data flow and a downstream service data flow. Correspondingly, the description information of the service data flow may also include upstream data description information and downstream data description information.

In an example, the upstream service data flow and the downstream service data flow may be indicated in same service data flow description information. For example, the service data flow description information may be represented as {Upstream service data flow: “Source IP address a, Source port a, Target IP address b, Target port b, Transmission protocol c”, Downstream service data flow: “Source IP address b, Source port b, Target IP address a, Target port a, Transmission protocol c”}.

In another example, the upstream service data flow and the downstream service data flow may be indicated in different service data flow description information. For example, the upstream service data flow may be indicated in the upstream data description information, and the downstream service data flow may be indicated in the downstream data description information. For example, service data flow description information of the upstream service data flow may be represented as {“Source IP address a, Source port a, Target IP address b, Target port b, Transmission protocol c”}, and service data flow description information of the downstream service data flow may be represented as {“Source IP address b, Source port b, Target IP address a, Target port a, Transmission protocol c”}.

In some embodiments, when the upstream service data flow and the downstream service data flow are indicated in different service data flow description information, the PCC rule may include a first PCC rule, a second PCC rule, and the first RTT control information. The first PCC rule may include an uplink transmission delay requirement corresponding to the upstream service data flow, and the second PCC rule may include a downlink transmission delay requirement corresponding to the downstream service data flow.

In some embodiments, the uplink transmission delay requirement in the first PCC rule may be different from (not equal to) the downlink transmission delay requirement in the second PCC rule. For example, the first PCC rule may include the upstream data description information and the uplink transmission delay requirement that correspond to the upstream service data flow, for example, the uplink transmission delay requirement is 50 ms. The second PCC rule includes the downstream data description information and the downlink transmission delay requirement that correspond to the downstream service data flow, for example, the downlink transmission delay requirement is 150 ms.

Based on this, in some embodiments, the first RTT control information, the uplink transmission delay requirement, and the downlink transmission delay requirement may be used to jointly indicate the RTT requirement corresponding to the service data flow. The first RTT control information indicates that the RTT control needs to be performed on the service data flow. The specific RTT requirement may be obtained according to the uplink transmission delay requirement and the downlink transmission delay requirement. In other words, the first RTT control information, the uplink transmission delay requirement, and the downlink transmission delay requirement may be used to indicate that the RTT requirement corresponding to the service data flow is equal to a sum of the uplink transmission delay requirement and the downlink transmission delay requirement. In an example, the uplink transmission delay requirement is 50 ms, the downlink transmission delay requirement is 150 ms, and the first RTT control information, the uplink transmission delay requirement, and the downlink transmission delay requirement are used to jointly indicate the RTT requirement corresponding to the service data flow, it may be learned that the RTT requirement is equal to a sum of the uplink transmission delay requirement and the downlink transmission delay requirement, that is, the RTT requirement is 200 ms. The RTT requirement is used to indicate that the actual RTT of the service data flow cannot exceed the RTT requirement.

It should be noted that when the first RTT control information, the uplink transmission delay requirement, and the downlink transmission delay requirement are used to jointly indicate the RTT requirement corresponding to the service data flow, priority may be given to meeting the corresponding RTT requirement, and then the uplink transmission delay requirement or the downlink transmission delay requirement or both are considered. Alternatively, only meeting the corresponding RTT requirement is considered, and the uplink transmission delay requirement or the downlink transmission delay requirement or both do not need to be considered. In an example, when the uplink transmission delay requirement is 50 ms, the downlink transmission delay requirement is 150 ms, and an actual uplink transmission delay is 30 ms, a downlink transmission delay may be appropriately slowed down, for example, may be slowed down to 90 ms, 150 ms, or the like. A preset downstream limitation of 150 ms may even be exceeded, and the downlink transmission delay is slowed down to 160 ms, 170 ms, or the like.

In some embodiments, the uplink transmission delay requirement and/or the downlink transmission delay requirement may be indicated by using a QoS identifier, for example, may be indicated by using a 5QI. For specific content of the QoS identifier, refer to the foregoing description. Details are not described herein again.

In some embodiments, when the PCC rule includes the first PCC rule and the second PCC rule, two QoS flows may be determined according to the first PCC rule and the second PCC rule, to respectively transmit the upstream service data flow and the downstream service data flow. That the two QoS flows are respectively a first QoS flow and a second QoS flow is used as an example. A service data flow (for example, the upstream service data flow) corresponding to the first QoS flow may be transmitted by using the first QoS flow, and a service data flow (for example, the downstream service data flow) corresponding to the second QoS flow may be transmitted by using the second QoS flow.

Correspondingly, in some embodiments, the second RTT control information, a transmission delay requirement corresponding to the first QoS flow, and a transmission delay requirement corresponding to the second QoS flow may be used to jointly indicate an RTT requirement corresponding to a QoS flow. The second RTT control information indicates that RTT control needs to be performed on the QoS flow. The specific RTT requirement may be obtained according to the transmission delay requirement corresponding to the first QoS flow and the transmission delay requirement corresponding to the second QoS flow. In other words, the second RTT control information, the transmission delay requirement corresponding to the first QoS flow, and the transmission delay requirement corresponding to the second QoS flow may be used to indicate that the RTT requirement corresponding to the QoS flow is equal to a sum of the transmission delay requirement corresponding to the first QoS flow and the transmission delay requirement corresponding to the second QoS flow. In an example, the transmission delay requirement corresponding to the first QoS flow is 50 ms, the transmission delay requirement corresponding to the second QoS flow is 150 ms, and the second RTT control information, the transmission delay requirement corresponding to the first QoS flow, and the transmission delay requirement corresponding to the second QoS flow are used to jointly indicate the RTT requirement corresponding to the QoS flow, it may be learned that the RTT requirement is equal to a sum of the transmission delay requirement corresponding to the first QoS flow and the transmission delay requirement corresponding to the second QoS flow, that is, the RTT requirement is 200 ms. The RTT requirement is used to indicate that the actual RTT of the service data flow cannot exceed the RTT requirement.

In some embodiments, the PCF may receive a request sent by the AF, and then determine the first RTT control information corresponding to the service data flow according to the request. Continuing to refer to FIG. 4 again, in some embodiments, before step S310, the communication method may further include step S302 and step S304.

In step S302, the PCF receives a request of the AF. The request includes an RTT demand corresponding to the service data flow.

In some embodiments, the RTT demand may be data of a numeric type, for example, the RTT demand may be a fixed value. For example, the RTT demand corresponding to the service data flow may be 200 ms. Alternatively, the RTT demand may also be a changing value.

In some embodiments, the RTT demand may be indication information, and the indication information may be used to instruct to control the RTT of the service data flow.

In some embodiments, the request may further include a first transmission delay requirement, and the first transmission delay requirement may be used to indicate a single direction delay requirement corresponding to the service data flow.

In some embodiments, the request may further include an uplink transmission delay requirement corresponding to the upstream service data flow and a downlink transmission delay requirement corresponding to the downstream service data flow.

In some embodiments, the request may further include description information of the service data flow, for example, may include upstream data description information of the service data flow and downstream data description information of the service data flow.

In step S304, the PCF determines the first RTT control information according to the RTT demand.

In some embodiments, when the RTT demand is data of a numeric type, the PCF may directly generate the first RTT control information according to the RTT demand, and the first RTT control information may include, for example, an RTT requirement, which may be data of a numeric type. In an example, an RTT demand corresponding to a service data flow is 200 ms, and the PCF may generate first RTT control information according to the RTT demand, and the first RTT control information includes the RTT requirement of 200 ms.

In some embodiments, when the RTT demand in the request is indication information, and the request further includes the first transmission delay requirement, it may be indicated jointly according to the RTT demand and the first transmission delay requirement that the RTT requirement corresponding to the service data flow is equal to twice the first transmission delay requirement.

In some embodiments, when the RTT demand in the request is indication information, and the request further includes the uplink transmission delay requirement corresponding to the upstream service data flow and the downlink transmission delay requirement corresponding to the downstream service data flow, it may be jointly indicated according to the RTT demand, the uplink transmission delay requirement, and the downlink transmission delay requirement that the RTT requirement corresponding to the service data flow is equal to the sum of the uplink transmission delay requirement and the downlink transmission delay requirement.

In some embodiments, the RTT requirement, the single direction delay requirement, the first transmission delay requirement, the uplink transmission delay requirement, and the downlink transmission delay requirement mentioned in embodiments may all be indicated by using QoS identifiers or service types. For example, RTT requirements corresponding to different service types are different.

The AF directly provides the network side with the RTT demand corresponding to the service data flow of the target service, so that the network side may directly control, according to the RTT demand, the RTT corresponding to the service data flow. This improves timeliness of the control.

### Embodiment 2

FIG. 5 is a schematic flowchart of a communication method according to still another embodiment of this application. The method shown in FIG. 5 is described from a perspective of interaction between a PCF, an SMF, and an AF. The PCF, the SMF, and the AF may be, for example, the PCF, the SMF, and the AF shown in FIG. 1. The method shown in FIG. 5 includes step S510 to step S530.

In step S510, the PCF determines first RTT control information corresponding to a service data flow of a target service.

In some embodiments, the PCF may determine the first RTT control information according to information such as local configuration and an operator setting. In some embodiments, the PCF may determine the first RTT control information according to a request received from the AF.

In some embodiments, the first RTT control information may include an RTT requirement, which may be data of a numeric type. In some embodiments, the first RTT control information may be used to instruct to control an RTT of the service data flow.

In step S520, the PCF sends a policy control and charging PCC rule to the SMF. The service data flow includes an upstream service data flow and a downstream service data flow. The PCC rule includes a first PCC rule and a second PCC rule, the first PCC rule includes an uplink transmission delay requirement corresponding to the upstream service data flow, and the second PCC rule includes a downlink transmission delay requirement corresponding to the downstream service data flow. The first PCC rule or the second PCC rule or both further include a delay monitoring indication, and the delay monitoring indication is used to monitor an actual transmission delay of the upstream service data flow and/or the downstream service data flow.

In some embodiments, the uplink transmission delay requirement in the first PCC rule is different from (not equal to) the downlink transmission delay requirement in the second PCC rule. Based on this, the first PCC rule and the second PCC rule may be bound to different QoS flows, and the delay monitoring indication in the first PCC rule and the second PCC rule may be used to monitor actual transmission delays of QoS flows corresponding to the first PCC rule and the second PCC rule.

In an implementation, after receiving the PCC rule sent by the PCF, the SMF may start delay monitoring. Further, after receiving the actual transmission delays of the QoS flows sent by an access network device and/or a UPF, the SMF forwards a monitoring result to the PCF.

In step S530, the PCF adjusts the uplink transmission delay requirement or the downlink transmission delay requirement according to the received monitoring result and the first RTT control information.

It should be noted that if the monitoring result received by the PCF is for the upstream service data flow, the PCF may adjust the downlink transmission delay requirement corresponding to the downstream service data flow according to the monitoring result and the first RTT control information. If the monitoring result received by the PCF is for the downstream service data flow, the PCF may adjust the uplink transmission delay requirement corresponding to the upstream service data flow according to the monitoring result and the first RTT control information. Specifically, in an example, if the uplink transmission delay requirement is 50 ms, and the downlink transmission delay requirement is 150 ms, it may be determined that the RTT requirement corresponding to the first RTT control information is 200 ms. Based on this, if the monitoring result received by the PCF shows that the actual transmission delay of the upstream service data flow is 30 ms, the PCF may dynamically adjust the downlink transmission delay requirement according to the result and a first RTT control information. For example, the downlink transmission delay requirement may be adjusted from 150 ms to 160 ms, 170 ms, or the like.

In some embodiments, before step S510, the communication method may further include step S505. In step S505, the AF sends a request to the PCF. The request includes an RTT demand corresponding to the service data flow of the target service. Based on this, the PCF may determine the first RTT control information according to the RTT demand.

In some embodiments, the RTT demand may be data of a numeric type. In some embodiments, the RTT demand may be indication information, which is used to instruct a network side to control the RTT of the service data flow.

In this embodiment, the PCF may set a delay monitoring indication in the PCC rule, so that the RTT corresponding to the service data flow is directly controlled according to the monitoring result and the first RTT control information, without needing to feed back to an application layer for RTT control. This improves timeliness of control.

By using several examples, the following describes in detail the technical solutions provided in embodiments of this application from a perspective of cooperation between an AF, a PCF, an SMF, and an AN side, to better understand an implementation process of the solutions provided in embodiments of this application.

### Example 1

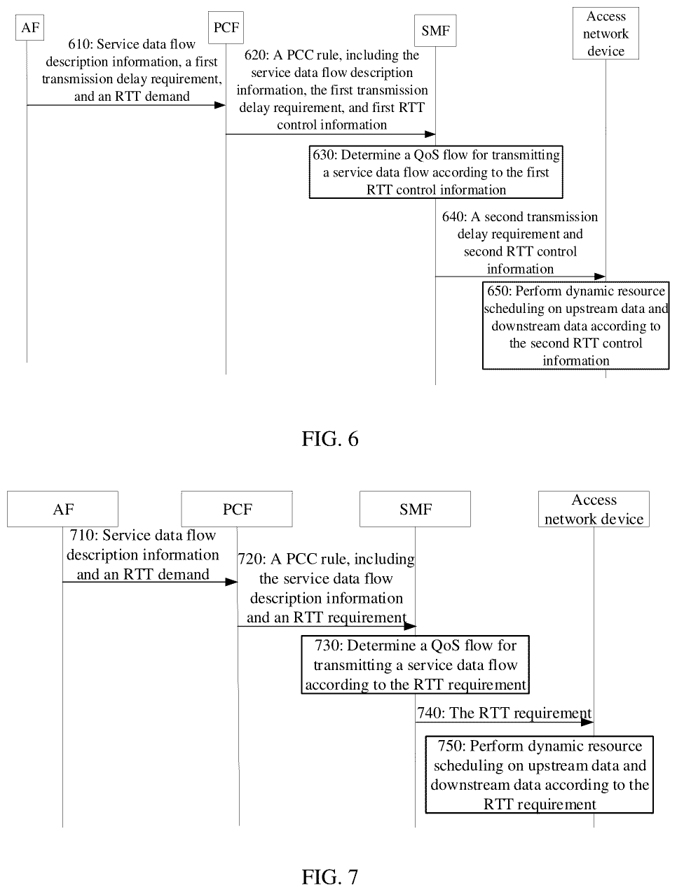

FIG. 6 is a schematic flowchart of a communication method according to yet another embodiment of this application. The method shown in FIG. 6 is described from a perspective of interaction between an AF, a PCF, an SMF, and an AN. The method shown in FIG. 6 may include step S610 to step S650.

In step S610, the AF may provide the PCF located in a core network with service data flow description information of a service data flow, a corresponding first transmission delay requirement, and a corresponding RTT demand. The RTT demand is indication information (an RTT indication), which is used to instruct to perform RTT control on the service data flow.

In some embodiments, the service data flow description information may be service data flow filter information. For example, filter information of data may be a feature of a packet header of user plane data. For example, for data of an IP type, the filter information of the data may include a source IP address, a target IP address, a source port number, a target port number, and the like. For data of an ethernet type, the filter information of the data may include a source MAC address, a target MAC address, and the like.

In this example, the service data flow description information includes upstream data description information and downstream data description information of the service data flow, and in this example, it may be considered that a transmission delay of upstream data is the same as that of downstream data. For example, if the service data flow description information is {Upstream flow “Source IP address a, Source port a, Target IP address b, Target port b, Transmission protocol c”, Downstream flow “Source IP address b, Source port b, Target IP address a, Target port a, Transmission protocol c”}, and the first transmission delay requirement is 100 ms, a transmission delay requirement of an upstream service data flow from a terminal device to a UPF does not exceed 100 ms, and a transmission delay requirement of a downstream service data flow from the UPF to the terminal device also does not exceed 100 ms. In this example, a request further includes the RTT demand, which is used to instruct a network side to control an RTT of the service data flow. That is, the RTT demand and the first transmission delay requirement may be used to indicate that a total requirement of a transmission delay of upstream data from the terminal device to the UPF+a transmission delay of downstream data from the UPF to the terminal device does not exceed 100 ms+100 ms=200 ms.

In step S620, the PCF may determine a PCC rule used for the service data flow according to a request of the AF, and send the PCC rule to the SMF. The PCC rule includes the service data flow description information of the service data flow, the first transmission delay requirement corresponding to the service data flow, and first RTT control information. The first transmission delay requirement is used to indicate a single direction delay requirement corresponding to the service data flow, and the first RTT control information is used to instruct to control the RTT of the service data flow.

In step S630, the SMF determines a QoS flow used to transmit the service data flow according to the PCC rule. For example, the SMF considers the first RTT control information, and transmits the service data flow corresponding to the PCC rule including the first RTT control information by using a separate QoS flow, and the QoS flow is only used to transmit the service data flow. Alternatively, the SMF considers the first RTT control information, and transmits the service data flow by using a QoS flow that has a same QoS requirement (for example, a same transmission delay) and has the first RTT control information. The QoS flow may further be used to transmit another service data flow that has the same QoS requirement and has the first RTT control information.

In step S640, the SMF sends a second transmission delay requirement corresponding to the QoS flow and second RTT control information to an access network device. The second RTT control information is used to instruct to control an RTT of the QoS flow. The second transmission delay requirement is determined according to the first transmission delay requirement, and the second RTT control information is determined according to the first RTT control information.

In step S650, the access network device performs dynamic resource scheduling on upstream data and downstream data according to the second RTT control information. For example, the access network device learns, according to information obtained from the SMF, that a single direction delay requirement corresponding to the QoS flow does not exceed 100 ms, and a corresponding RTT requirement does not exceed 200 ms. During resource scheduling, the access network device may consider the RTT requirement. In a case in which the RTT requirement is not exceeded, the access network device performs resource scheduling to dynamically adjust an actual uplink transmission delay and an actual downlink transmission delay. For example, when uplink transmission is relatively fast, the downlink transmission delay may be appropriately slowed down, or when the uplink transmission is relatively slow, the downlink transmission delay is appropriately accelerated.

For example, when the actual uplink transmission delay is 30 ms, the access network device may appropriately slow down the downlink transmission delay, for example, appropriately slow down the downlink transmission delay to 90 ms or 100 ms. In some embodiments, a preset single direction limitation of 100 ms may even be exceeded, and the downlink transmission may be slowed down to 150 ms or 170 ms.

### Example 2

FIG. 7 is a schematic flowchart of a communication method according to still yet another embodiment of this application. The method shown in FIG. 7 is described from a perspective of interaction between an AF, a PCF, an SMF, and an AN. The method shown in FIG. 7 may include step S710 to step S750.

In comparison with Example 1, in Example 2, the AF may directly provide the PCF of a core network with an RTT demand corresponding to a service data flow, without limiting a single direction delay requirement. In this example, the RTT demand may be in a numeric form, for example, a fixed value.

Specifically, in step S710, the AF provides the PCF located in the core network with service data flow description information of the service data flow and a corresponding RTT demand. For example, the RTT demand for the service data flow is 200 ms. This represents that a total demand of a transmission delay of an upstream service data flow from a terminal device to a UPF+a transmission delay of a downstream service data flow from the UPF to the terminal device does not exceed 200 ms.

In step S720, the PCF determines a PCC rule used for the service data flow according to a request of the AF, and sends the PCC rule to the SMF. The PCC rule includes the service data flow description information of the service data flow, and first RTT control information corresponding to the service data flow. The first RTT control information includes the RTT requirement.

In step S730, the SMF determines a QoS flow used to transmit the service data flow according to the PCC rule. For example, the SMF considers the RTT requirement, and transmits the service data flow corresponding to the PCC rule including the RTT requirement by using a separate QoS flow, and the QoS flow is only used to transmit the service data flow. Alternatively, the SMF considers the RTT requirement, and transmits the service data flow by using a QoS flow that has the same RTT requirement. The QoS flow may further be used to transmit another service data flow that has the same RTT requirement.

In step S740, the SMF sends second RTT control information corresponding to the QoS flow to an access network device, and the second RTT control information includes the RTT requirement. The second RTT control information is determined by the SMF according to the first RTT control information.

In step S750, the access network device performs dynamic resource scheduling on upstream data and downstream data according to the RTT requirement. For example, the access network device learns, according to information obtained from the SMF, that an RTT requirement of the QoS flow does not exceed 200 ms. During resource scheduling, the access network device may consider the RTT requirement. In a case in which the RTT requirement is not exceeded, the access network device performs resource scheduling to dynamically adjust an actual uplink transmission delay and an actual downlink transmission delay. For example, when uplink transmission is relatively fast, the downlink transmission delay may be appropriately slowed down, or when the uplink transmission is relatively slow, the downlink transmission delay is appropriately accelerated. For example, when an actual transmission delay of the upstream service data flow is 30 ms, the access network device may schedule a resource within a range in which downstream service data flow transmission does not exceed 170 ms. Alternatively, when an actual transmission delay of the downstream service data flow is 30 ms, the access network device may schedule a resource within a range in which upstream service data flow transmission does not exceed 170 ms.

### Example 3

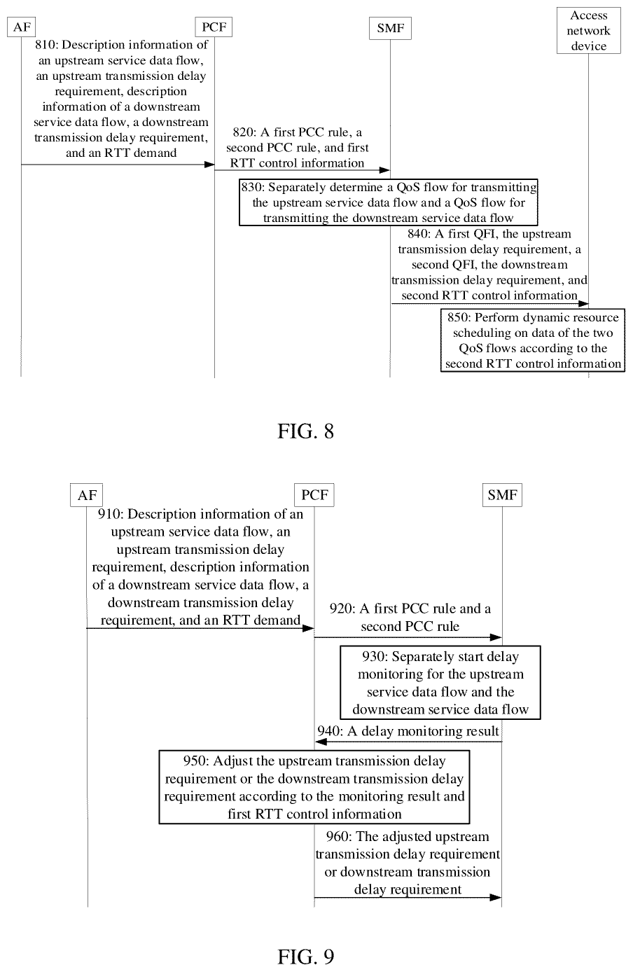

FIG. 8 is a schematic flowchart of a communication method according to a further embodiment of this application. The method shown in FIG. 8 is described from a perspective of interaction between an AF, a PCF, an SMF, and an AN. The method shown in FIG. 8 may include step S810 to step S850.

In comparison with Example 1, in Example 3, the AF may separately provide the PCF with an uplink transmission delay requirement corresponding to an upstream service data flow and a downlink transmission delay requirement corresponding to a downstream service data flow.

Specifically, in step S810, the AF may provide the PCF located in a core network with service data flow description information of an upstream service data flow and a corresponding uplink transmission delay requirement, service data flow description information of a downstream service data flow and a corresponding downlink transmission delay requirement, and an RTT demand, which is used to control RTTs of the two service data flows. In an example, the service data flow description information of the upstream service data flow is “Source IP address a, Source port a, Target IP address b, Target port b, Transmission protocol c”, the uplink transmission delay requirement is 50 ms, the service data flow description information of the downstream service data flow is “Source IP address b, Source port b, Target IP address a, Target port a, Transmission protocol c”, the downlink transmission delay requirement is 150 ms, and the RTT demand may be used to indicate that a total transmission delay requirement of the upstream service data flow and the downstream service data flow does not exceed 50 ms+150 ms=200 ms.

In step S820, the PCF determines a PCC rule used for the service data flow according to a request of the AF, and sends the PCC rule to the SMF. The PCC rule may include a first PCC rule, a second PCC rule, and first RTT control information. The first PCC rule may include the service data flow description information of the upstream service data flow and the transmission delay requirement of the upstream service data flow. The second PCC rule may include the service data flow description information of the downstream service data flow and the transmission delay requirement of the downstream service data flow. The first RTT control information is used to instruct to control the RTTs of the service data flows, is determined according to the RTT demand, and is used to instruct to perform RTT control on the service data flows corresponding to the two PCC rules. In other words, the PCF may determine different PCC rules for the upstream service data flow and the downstream service data flow.

In step S830, the SMF separately determines a QoS flow used to transmit the upstream service data flow and a QoS flow used to transmit the downstream service data flow. For example, the SMF may bind the two service data flows to the two QoS flows according to different transmission delays in the first PCC rule and the second PCC rule. Optionally, the SMF may further determine, according to the first RTT control information, that each QoS flow is used to transmit only one service data flow, that is, the QoS flow is not shared with another service data flow.

In step S840, the SMF sends the transmission delay requirement of each QoS flow and second RTT control information to an access network device. The second RTT control information is determined by the SMF according to the first RTT control information, and the second RTT control information is used to instruct to control an RTT of the QoS flow, and is used to instruct the access network device to control the round-trip times of the two QoS flows.

In step S850, the access network device performs dynamic resource scheduling on data of the two QoS flows according to the second RTT control information. For example, the access network device learns, according to information obtained from the SMF, that the transmission delay requirements of the two QoS flows respectively do not exceed 50 ms and 150 ms, and the RTT requirement of the two QoS flows does not exceed 200 ms. During resource scheduling, the access network device may consider the RTT requirement. In a case in which the RTT requirement is not exceeded, the access network device performs resource scheduling to dynamically adjust actual transmission delays of the two QoS flows. For example, when transmission of the first QoS flow is relatively fast, a transmission delay of the second QoS flow may be appropriately slowed down, or when the transmission of the first QoS flow is relatively slow, the transmission delay of the second QoS flow is appropriately accelerated. In an example, when the actual transmission delay of the first QoS flow is 30 ms, the second QoS flow may be appropriately slowed down to 140 ms. In some embodiments, a preset single direction limitation of 150 ms is even exceeded, for example, the second QoS flow is slowed down to 160 ms.

### Example 4

FIG. 9 is a schematic flowchart of a communication method according to a still further embodiment of this application. The method shown in FIG. 9 is described from a perspective of interaction between an AF, a PCF, and an SMF. The method shown in FIG. 9 may include step S910 to step S960.

In example 4, the PCF may control an RTT of a service data flow, for example, a delay monitoring indication is set in a PCC rule. After the SMF reports a monitoring result to the PCF, the PCF may dynamically adjust a transmission delay requirement of the service data flow according to the monitoring result.

Specifically, in step S910, the AF may provide the PCF located in a core network with service data flow description information of an upstream service data flow and a corresponding uplink transmission delay requirement, service data flow description information of a downstream service data flow and a corresponding downlink transmission delay requirement, and an RTT demand, which is used to control RTTs of the two service data flows.

In step S920, the PCF may set the delay monitoring indication in the PCC rule according to a request of the AF, and send the PCC rule to the SMF, for example, may set the delay monitoring indication in a first PCC rule and/or a second PCC rule. In an example, the PCF may send, to the SMF, the first PCC rule (including the service data flow description information of the upstream service data flow, the uplink transmission delay requirement, and the delay monitoring indication) and the second PCC rule (including the service data flow description information of the downstream service data flow, the downlink transmission delay requirement, and the delay monitoring indication). It should be noted that the delay monitoring indication may be set only in the first PCC rule or only in the second PCC rule, which is not limited in this application.

In step S930, the SMF determines a QoS flow used to transmit the service data flow according to the PCC rule, and starts delay monitoring for the upstream service data flow and/or the downstream service data flow. For example, the SMF may bind the two service data flows to two QoS flows according to different transmission delays. Each QoS flow is used to transmit only one service data flow, that is, the QoS flow is not shared with another service data flow.

In step S940, after starting monitoring of an actual transmission delay of a QoS flow, the SMF may report a monitoring result to the PCF.

In step S950, the PCF adjusts the uplink transmission delay requirement or the downlink transmission delay requirement (for example, dynamically adjusts the uplink transmission delay requirement in the first PCC rule or the downlink transmission delay requirement in the second PCC rule) according to a report obtained from the SMF and first RTT control information. For example, when transmission of the upstream service data flow is relatively fast, the transmission delay requirement in the second PCC rule may be appropriately increased, or when the transmission of the upstream service data flow is relatively slow, the transmission delay requirement in the second PCC rule may be appropriately reduced. In an example, when an actual uplink transmission delay is 30 ms, the PCF may change the transmission delay requirement in the second PCC rule to 170 ms.

In step S960, the PCF sends the adjusted uplink transmission delay requirement or downlink transmission delay requirement to the SMF.

It should be noted that the examples provided in embodiments of this application are merely for ease of understanding of the solutions of this application, and shall not constitute any limitation on this application. This application may further recombine the solutions described above. The recombined solutions shall also be included in the protection scope of this application.

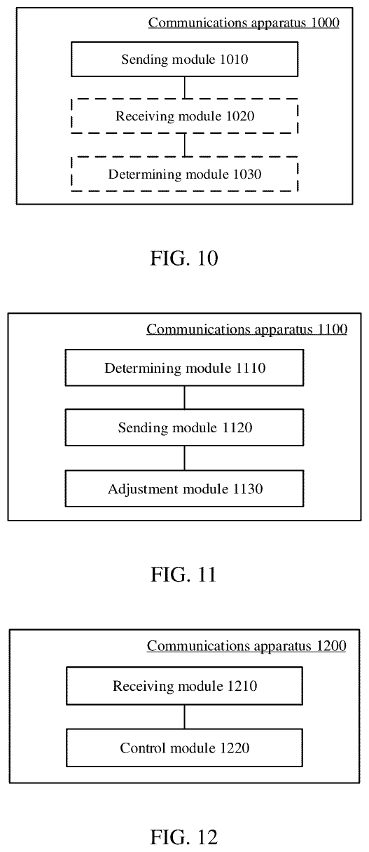

The foregoing describes method embodiments of this application in detail with reference to FIG. 1 to FIG. 9. The following describes apparatus embodiments of this application in detail with reference to FIG. 10 to FIG. 15. It should be understood that the description of the method embodiments corresponds to the description of the apparatus embodiments, and therefore, for parts that are not described in detail, refer to the foregoing method embodiments.

FIG. 10 is a schematic structural diagram of a communications apparatus according to an embodiment of this application. The communications apparatus 1000 shown in FIG. 10 may be a PCF entity, and the communications apparatus 1000 may include a sending module 1010.

The sending module 1010 may be configured to send a policy control and charging PCC rule to a session management function SMF, where the PCC rule includes first round-trip time RTT control information corresponding to a service data flow of a target service, and the PCC rule is used by the SMF to control, according to the first RTT control information, a quality of service QoS flow for transmitting the service data flow.

Optionally, the first RTT control information is further used to instruct to control an RTT of the service data flow.

Optionally, the PCC rule further includes a first transmission delay requirement, and the first transmission delay requirement is used to indicate a single direction delay requirement corresponding to the service data flow.

Optionally, the first RTT control information and the first transmission delay requirement are used to indicate that an RTT requirement corresponding to the service data flow is equal to twice the first transmission delay requirement.

Optionally, the service data flow includes an upstream service data flow and a downstream service data flow, the PCC rule includes a first PCC rule, a second PCC rule, and the first RTT control information, the first PCC rule includes an uplink transmission delay requirement corresponding to the upstream service data flow, and the second PCC rule includes a downlink transmission delay requirement corresponding to the downstream service data flow.

Optionally, the uplink transmission delay requirement is different from the downlink transmission delay requirement.

Optionally, the QoS flow includes a first QoS flow and a second QoS flow, the first QoS flow is used to transmit the upstream service data flow, and the second QoS flow is used to transmit the downstream service data flow.

Optionally, the QoS flow includes a first QoS flow and a second QoS flow, the first QoS flow is used to transmit the upstream service data flow, and the second QoS flow is used to transmit the downstream service data flow.

Optionally, the first RTT control information includes the RTT requirement corresponding to the service data flow.

Optionally, an actual RTT of the service data flow does not exceed the RTT requirement.

Optionally, the PCF entity further includes a receiving module 1020 and a determining module 1030. The receiving module 1020 may be configured to receive a request of an application function AF, where the request includes an RTT demand corresponding to the service data flow. The determining module 1030 may be configured to determine the first RTT control information according to the RTT demand.

Optionally, the QoS flow is only used to transmit the service data flow that includes the target service.

Optionally, the QoS flow is used to transmit the service data flow and a service data flow that has the same first RTT control information as the service data flow that includes the target service.

Optionally, the PCC rule further includes description information of the service data flow.

Optionally, the description information includes upstream data description information of the service data flow and downstream data description information of the service data flow.

Optionally, a QoS identifier is used to indicate an RTT requirement and/or a single direction delay requirement corresponding to the service data flow.

FIG. 11 is a schematic structural diagram of a communications apparatus according to another embodiment of this application. The communications apparatus 1100 shown in FIG. 11 may be a PCF entity, and the communications apparatus 1100 may include a determining module 1110, a sending module 1120, and an adjustment module 1130.

The determining module 1110 may be configured to determine first round-trip time RTT control information corresponding to a service data flow of a target service.

The sending module 1120 may be configured to send a policy control and charging PCC rule to a session management function SMF, where the service data flow includes an upstream service data flow and a downstream service data flow, the PCC rule includes a first PCC rule and a second PCC rule, the first PCC rule includes an uplink transmission delay requirement corresponding to the upstream service data flow, the second PCC rule includes a downlink transmission delay requirement corresponding to the downstream service data flow, a delay monitoring indication is further included in the first PCC rule and/or the second PCC rule, and the delay monitoring indication is used to monitor an actual transmission delay of the upstream service data flow and/or the downstream service data flow.

The adjustment module 1130 may be configured to adjust the uplink transmission delay requirement or the downlink transmission delay requirement according to a received monitoring result and the first RTT control information.

Optionally, the adjustment module 1130 is further configured to: if the monitoring result is for the upstream service data flow, adjust the downlink transmission delay requirement according to the monitoring result and the first RTT control information; or if the monitoring result is for the downstream service data flow, adjust the uplink transmission delay requirement according to the monitoring result and the first RTT control information.

Optionally, the uplink transmission delay requirement is different from the downlink transmission delay requirement.

Optionally, the communications apparatus 1100 further includes a receiving module, and the receiving module may be configured to receive a request of an application function AF, where the request includes an RTT demand corresponding to the service data flow. The determining module 1110 may further be configured to determine the first RTT control information according to the RTT demand.

Optionally, the first RTT control information is further used to instruct to control an RTT of the service data flow.

Optionally, the PCC rule further includes description information of the service data flow.

Optionally, the description information includes upstream data description information of the service data flow and downstream data description information of the service data flow.

FIG. 12 is a schematic structural diagram of a communications apparatus according to still another embodiment of this application. The communications apparatus 1200 shown in FIG. 12 may be an SMF entity, and the communications apparatus 1200 may include a receiving module 1210 and a control module 1220.

The receiving module 1210 may be configured to receive a policy control and charging PCC rule sent by a policy control function PCF, where the PCC rule includes first round-trip time RTT control information corresponding to a service data flow of a target service.

The control module 1220 may be configured to control, according to the first RTT control information, a quality of service QoS flow for transmitting the service data flow.

Optionally, the first RTT control information is further used to instruct to control an RTT of the service data flow.

Optionally, the PCC rule further includes a first transmission delay requirement, and the first transmission delay requirement is used to indicate a single direction delay requirement corresponding to the service data flow.

Optionally, the first RTT control information and the first transmission delay requirement are used to indicate that an RTT requirement corresponding to the service data flow is equal to twice the first transmission delay requirement.

Optionally, the service data flow includes an upstream service data flow and a downstream service data flow, the PCC rule includes a first PCC rule, a second PCC rule, and the first RTT control information, the first PCC rule includes an uplink transmission delay requirement corresponding to the upstream service data flow, and the second PCC rule includes a downlink transmission delay requirement corresponding to the downstream service data flow.

Optionally, the uplink transmission delay requirement is different from the downlink transmission delay requirement.

Optionally, the QoS flow includes a first QoS flow and a second QoS flow, the first QoS flow is used to transmit the upstream service data flow, and the second QoS flow is used to transmit the downstream service data flow.

Optionally, the first RTT control information, the uplink transmission delay requirement, and the downlink transmission delay requirement are used to indicate that the RTT requirement corresponding to the service data flow is equal to a sum of the uplink transmission delay requirement and the downlink transmission delay requirement.

Optionally, the first RTT control information includes the RTT requirement corresponding to the service data flow.

Optionally, an actual RTT of the service data flow does not exceed the RTT requirement.

Optionally, the control module 1220 is further configured to determine the QoS flow according to the first RTT control information, where the QoS flow is only used to transmit the service data flow.

Optionally, the control module 1220 is further configured to determine the QoS flow according to the first RTT control information, where the QoS flow is used to transmit the service data flow that includes the target service and a service data flow that has the same first RTT control information as the service data flow that includes the target service.

Optionally, the control module 1220 is further configured to send control information of the QoS flow to an access network device, where the control information of the QoS flow includes second RTT control information corresponding to the QoS flow.

Optionally, the second RTT control information is determined by the SMF according to the first RTT control information.

Optionally, the PCC rule further includes description information of the service data flow.

Optionally, the description information includes upstream data description information of the service data flow and downstream data description information of the service data flow.

Optionally, a QoS identifier is used to indicate an RTT requirement and/or a single direction delay requirement corresponding to the service data flow.

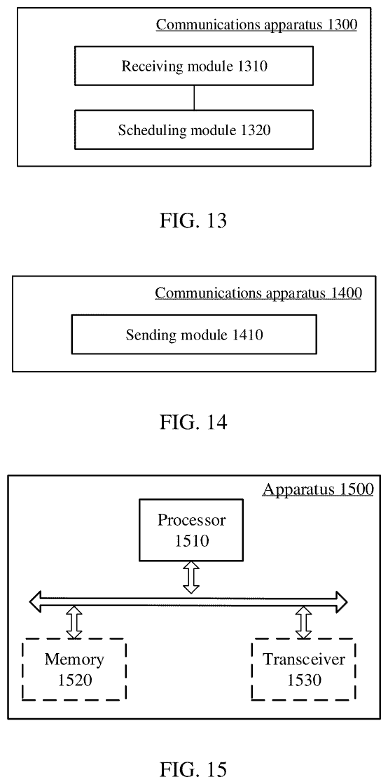

FIG. 13 is a schematic structural diagram of a communications apparatus according to yet another embodiment of this application. The communications apparatus 1300 shown in FIG. 13 may be an access network device, and the communications apparatus 1300 may include a receiving module 1310 and a scheduling module 1320.

The receiving module 1310 may be configured to receive control information of a quality of service QoS flow sent by a session management function SMF, where the control information of the QoS flow includes second round-trip time RTT control information corresponding to the QoS flow.

The scheduling module 1320 may be configured to schedule a radio resource according to the control information of the QoS flow, to perform RTT control on the QoS flow.

Optionally, the second RTT control information is further used to instruct to control an RTT of the QoS flow.

Optionally, the control information of the QoS flow further includes a second transmission delay requirement, and the second transmission delay requirement is used to indicate a single direction delay requirement corresponding to the QoS flow.

Optionally, the second RTT control information and the second transmission delay requirement are used to indicate that an RTT requirement corresponding to the QoS flow is equal to twice the second transmission delay requirement.

Optionally, the QoS flow includes a first QoS flow and a second QoS flow, the control information of the QoS flow includes control information of the first QoS flow, control information of the second QoS flow, and the second RTT control information, the control information of the first QoS flow includes a transmission delay requirement corresponding to the first QoS flow, and the control information of the second QoS flow includes a transmission delay requirement corresponding to the second QoS flow.

Optionally, the transmission delay requirement corresponding to the first QoS flow is different from the transmission delay requirement corresponding to the second QoS flow.

Optionally, the second RTT control information, the transmission delay requirement corresponding to the first QoS flow, and the transmission delay requirement corresponding to the second QoS flow are used to indicate that an RTT requirement corresponding to the QoS flow is equal to a sum of the transmission delay requirement corresponding to the first QoS flow and the transmission delay requirement corresponding to the second QoS flow.

Optionally, the second RTT control information includes an RTT requirement corresponding to the QoS flow.

Optionally, an actual RTT of the QoS flow does not exceed the RTT requirement.

Optionally, a QoS identifier is used to indicate an RTT requirement and/or a single direction delay requirement corresponding to the QoS flow.

FIG. 14 is a schematic structural diagram of a communications apparatus according to still yet another embodiment of this application. The communications apparatus 1400 shown in FIG. 14 may be an AF entity, and the communications apparatus 1400 may include a sending module 1410.

The sending module 1410 may be configured to send a request to a policy control function PCF, where the request includes a round-trip time RTT demand corresponding to a service data flow of a target service, the request is used by the PCF to determine a policy control and charging PCC rule corresponding to the service data flow according to the RTT demand, and the PCC rule includes first RTT control information corresponding to the service data flow.

Optionally, the first RTT control information is further used to instruct to control an RTT of the service data flow.

Optionally, the request further includes a first transmission delay requirement, and the first transmission delay requirement is used to indicate a single direction delay requirement corresponding to the service data flow.

Optionally, the first RTT control information and the first transmission delay requirement are used to indicate that an RTT requirement corresponding to the service data flow is equal to twice the first transmission delay requirement.

Optionally, the service data flow includes an upstream service data flow and a downstream service data flow, and the request includes an uplink transmission delay requirement corresponding to the upstream service data flow and a downlink transmission delay requirement corresponding to the downstream service data flow.

Optionally, the PCC rule includes a first PCC rule, a second PCC rule, and the first RTT control information, the first PCC rule includes the uplink transmission delay requirement corresponding to the upstream service data flow, and the second PCC rule includes the downlink transmission delay requirement corresponding to the downstream service data flow.

Optionally, the uplink transmission delay requirement is different from the downlink transmission delay requirement.

Optionally, the first RTT control information, the uplink transmission delay requirement, and the downlink transmission delay requirement are used to indicate that an RTT requirement corresponding to the service data flow is equal to a sum of the uplink transmission delay requirement and the downlink transmission delay requirement.

Optionally, the first RTT control information includes an RTT requirement corresponding to the service data flow.

Optionally, an actual RTT of the service data flow does not exceed the RTT requirement.

Optionally, the request further includes description information of the service data flow, the PCC rule includes the description information of the service data flow.

Optionally, the description information includes upstream data description information of the service data flow and downstream data description information of the service data flow.

Optionally, a QoS identifier or a service type is used to indicate the RTT requirement and/or a single direction delay requirement corresponding to the service data flow.

FIG. 15 is a schematic structural diagram of an apparatus according to an embodiment of this application. The dashed lines in FIG. 15 indicate that the unit or module is optional. The apparatus 1500 may be configured to implement the methods described in the method embodiments. The apparatus 1500 may be a chip or a communications device (such as a PCF entity, an SMF entity, an access network device, or an AF entity).

The apparatus 1500 may include one or more processors 1510. The processor 1510 may allow the apparatus 1500 to implement the methods described in the foregoing method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program that may be executed by the processor 1510 to cause the processor 1510 to execute the methods described in the foregoing method embodiments. The memory 1520 may be independent of the processor 1510 or may be integrated into the processor 1510.

The apparatus 1500 may further include a transceiver 1530. The processor 1510 may communicate with another device or chip through the transceiver 1530. For example, the processor 1510 may send and receive data to and from another device or chip through the transceiver 1530.

An embodiment of this application further provides a computer-readable storage medium for storing a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B that is corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes shall be determined according to functions and internal logic of the processes, and shall not constitute any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communications apparatus, wherein the communications apparatus is a policy control function (PCF), and the communications apparatus comprises a memory and a processor, wherein the memory is configured to store a program, and the processor is configured to invoke the program in the memory to cause the communications apparatus at least to:
determine first round-trip time (RTT) control information corresponding to a service data flow of a target service;
send a policy control and charging (PCC) rule to a session management function (SMF), wherein the service data flow comprises an upstream service data flow and a downstream service data flow, the PCC rule comprises a first PCC rule and a second PCC rule, the first PCC rule comprises an uplink transmission delay requirement corresponding to the upstream service data flow, the second PCC rule comprises a downlink transmission delay requirement corresponding to the downstream service data flow, a delay monitoring indication is further comprised in the first PCC rule and/or the second PCC rule, and the delay monitoring indication is used to monitor an actual transmission delay of the upstream service data flow and/or the downstream service data flow; and
adjust the uplink transmission delay requirement or the downlink transmission delay requirement according to a received monitoring result and the first RTT control information.

2. The communications apparatus according to claim 1, wherein a 5G QoS identifier (5QI) is used to indicate the uplink transmission delay requirement and/or the downlink transmission delay requirement.

3. The communications apparatus according to claim 1, wherein the PCC rule is generated by the PCF.

4. The communications apparatus according to claim 1, wherein the adjust the uplink transmission delay requirement or the downlink transmission delay requirement according to a received monitoring result and the first RTT control information comprises:
if the monitoring result is for the upstream service data flow, adjust the downlink transmission delay requirement according to the monitoring result and the first RTT control information; or
if the monitoring result is for the downstream service data flow, adjust the uplink transmission delay requirement according to the monitoring result and the first RTT control information.

5. The communications apparatus according to claim 1, wherein the uplink transmission delay requirement is different from the downlink transmission delay requirement.

6. The communications apparatus according to claim 5, wherein the uplink transmission delay requirement is different from the downlink transmission delay requirement comprises:
a packet delay budget (PDB) indicated by a 5QI used to indicate the uplink transmission delay requirement is different from a PDB indicated by a 5QI used to indicate the downlink transmission delay requirement.

7. The communications apparatus according to claim 1, wherein the processor is configured to invoke the program in the memory to cause the communications apparatus further:
receive a request of an application function (AF), wherein the request comprises an RTT demand corresponding to the service data flow; and
the determine first RTT control information corresponding to a service data flow of a target service comprises:
determine the first RTT control information according to the RTT demand.

8. The communications apparatus according to claim 7, wherein the RTT demand is indication information, the request further comprises a first transmission delay requirement, and an RTT requirement corresponding to the service data flow is equal to twice the first transmission delay requirement.

9. The communications apparatus according to claim 8, wherein the first transmission delay requirement is used to indicate a single direction delay requirement corresponding to the service data flow.

10. The communications apparatus according to claim 7, wherein the RTT demand is indication information, the request further comprises an uplink transmission delay requirement corresponding to the upstream service data flow and a downlink transmission delay requirement corresponding to the downstream service data flow, and an RTT requirement corresponding to the service data flow is equal to a sum of the uplink transmission delay requirement and the downlink transmission delay requirement.

11. The communications apparatus according to claim 7, wherein the first RTT control information comprises an RTT requirement corresponding to the service data flow.

12. A communications apparatus, wherein the communications apparatus is a session management function (SMF), and the communications apparatus comprises a memory and a processor, wherein the memory is configured to store a program, and the processor is configured to invoke the program in the memory to cause the communications apparatus at least to:
receive a policy control and charging (PCC) rule from a policy control function (PCF), wherein the PCC rule comprises a first PCC rule and a second PCC rule, the first PCC rule comprises an uplink transmission delay requirement corresponding to an upstream service data flow of a service data flow, the second PCC rule comprises a downlink transmission delay requirement corresponding to a downstream service data flow of the service data flow, a delay monitoring indication is further comprised in the first PCC rule and/or the second PCC rule, and the delay monitoring indication is used to monitor an actual transmission delay of the upstream service data flow and/or the downstream service data flow.

13. The communications apparatus according to claim 12, wherein the uplink transmission delay requirement is different from the downlink transmission delay requirement.

14. A communications apparatus, wherein the communications apparatus is an application function (AF), and the communications apparatus comprises a memory and a processor, wherein the memory is configured to store a program, and the processor is configured to invoke the program in the memory to cause the communications apparatus at least to:
send a request to a policy control function (PCF), wherein the request is used by the PCF to determine first round-trip time (RTT) control information corresponding to a service data flow of a target service, the service data flow comprises an upstream service data flow and a downstream service data flow, the PCC rule comprises a first PCC rule and a second PCC rule, the first PCC rule comprises an uplink transmission delay requirement corresponding to the upstream service data flow, the second PCC rule comprises a downlink transmission delay requirement corresponding to the downstream service data flow, a delay monitoring indication is further comprised in the first PCC rule and/or the second PCC rule, and the delay monitoring indication is used to monitor an actual transmission delay of the upstream service data flow and/or the downstream service data flow.

15. The communications apparatus according to claim 14, wherein the uplink transmission delay requirement is different from the downlink transmission delay requirement.

16. The communications apparatus according to claim 14, wherein the request comprises an RTT demand corresponding to the service data flow, and the first RTT control information is determined according to the RTT demand.

17. The communications apparatus according to claim 16, wherein the RTT demand is indication information, the request further comprises a first transmission delay requirement, and an RTT requirement corresponding to the service data flow is equal to twice the first transmission delay requirement.

18. The communications apparatus according to claim 17, wherein the first transmission delay requirement is used to indicate a single direction delay requirement corresponding to the service data flow.

19. The communications apparatus according to claim 16, wherein the RTT demand is indication information, the request further comprises an uplink transmission delay requirement corresponding to the upstream service data flow and a downlink transmission delay requirement corresponding to the downstream service data flow, and an RTT requirement corresponding to the service data flow is equal to a sum of the uplink transmission delay requirement and the downlink transmission delay requirement.

20. The communications apparatus according to claim 16, wherein the first RTT control information comprises an RTT requirement corresponding to the service data flow.
